(19) United States
(12) Patent Application Publication
(10) Pub. No.: US 2015/0040345 A1
(43) Pub. Date: Feb. 12, 2015

(54) VEHICLE GROMMET AND METHOD

(71) Applicant: Honda Motor Co., Ltd., Tokyo (JP)

(72) Inventor: Allen R. Loy, Columbus, OH (US)

(73) Assignee: Honda Motor Co., Ltd., Tokyo (JP)

(21) Appl. No.: 13/960,582

(22) Filed: Aug. 6, 2013

(51) Int. Cl. B60R 16/02; H02G 1/06; F16B 5/06

(52) U.S. Cl. CPC B60R 16/0222; F16B 5/0642; F16B 5/0664; H02G 1/06
USPC 16/2.1; 29/428

(57) ABSTRACT

A vehicle grommet includes a cylindrical body having a first axial end and a second axial end, a first circumferential groove defined into the cylindrical body at a first location spaced between the first and second axial ends and a second circumferential groove defined in the cylindrical body at a second location spaced between the first and second axial ends and spaced apart from the first circumferential groove. The first circumferential groove is configured to mount the cylindrical body within a first panel aperture defined in an associated first panel. The second circumferential groove is configured to mount the cylindrical body within in a second panel aperture defined in an associated second panel. A first panel aperture diameter of the first panel aperture varies relative to a second panel aperture diameter of the second panel aperture.

### BACKGROUND

Vehicle assembly continues to evolve and increasingly must be flexible enough to accommodate vehicles of different designs within single assembly plants and/or even on a single assembly line. There are, of course, many variations among vehicle designs. Variations can occur between vehicle models manufactured by the same vehicle manufacturer. Variations can even occur within the same model type for a vehicle manufacturer. For example, variations could occur between a two wheel drive vehicle model and a four wheel drive vehicle model. Such variations can sometimes include varying body panel thickness, and hole diameters within body panels, etc.

Grommets are frequently used to secure vehicle panels during vehicle assembly. When body panel thicknesses and/or body panel grommet apertures vary between vehicles, particularly when the vehicles are manufactured on a single assembly line, it requires the manufacturer to ensure that the correct grommet is used for a given body panel. For example, one vehicle model or vehicle type of a given model may have a body panel with a first thickness and/or a first hole diameter that requires usage of a first grommet type and a second vehicle model or vehicle type may have a body panel having a second thickness and/or a second hole diameter that requires usage of a second grommet type.

### SUMMARY

According to one aspect, a vehicle grommet includes a cylindrical body having a first axial end and a second axial end, a first circumferential groove defined into the cylindrical body at a first location spaced between the first and second axial ends and a second circumferential groove defined in the cylindrical body at a second location spaced between the first and second axial ends and spaced apart from the first circumferential groove. The first circumferential groove is configured to mount the cylindrical body within a first panel aperture defined in an associated first panel. The second circumferential groove is configured to mount the cylindrical body within in a second panel aperture defined in an associated second panel. A first panel aperture diameter of the first panel aperture varies relative to a second panel aperture diameter of the second panel aperture.

According to another aspect, a wire harness grommet for use in vehicle assembly includes a body having a first end and a second end with an outer wall extending from the first end to the second end. The second end is adapted to be inserted through a grommet aperture defined in an associated panel. The wire harness grommet further includes a first aperture defined in the outer wall and sized to accommodate the associated panel when the grommet aperture has a first diameter and a second aperture defined in the outer wall and sized to accommodate the associated panel when the grommet aperture has a second diameter that is smaller than the first diameter.

According to further aspect, a grommet installation method for a vehicle includes providing a grommet having a cylindrical body with a first axial end and a second axial end, wherein the cylindrical body defines a first circumferential groove adapted for mounting within a panel aperture defined in an associated panel when the panel aperture has a first panel aperture diameter and a second circumferential groove adapted to mount the cylindrical body within the panel aperture when the panel aperture has a second panel aperture diameter. The first panel aperture diameter varies relative to the second panel aperture diameter. The grommet installation method further includes installing the grommet within the associated panel such that the associated panel is received in the first circumferential groove when the panel aperture has the first panel aperture diameter and is received in the second circumferential groove when the panel aperture has the second panel aperture diameter.

### BRIEF DESCRIPTION OF THE DRAWINGS

FIG. 1 is a perspective view of a vehicle grommet according to an exemplary embodiment for use in vehicle assembly.

FIG. 2 is a cross sectional view of the vehicle grommet of FIG. 1.

FIG. 3 is a cross sectional view of the vehicle grommet similar to FIG. 2 but showing the grommet mounted in a grommet aperture of a vehicle panel having a specific diameter and thickness.

FIG. 4 is a cross sectional view of the vehicle grommet similar to FIG. 2 but showing the grommet mounted in another grommet aperture of a different vehicle panel having a different specific diameter and thickness.

### DETAILED DESCRIPTION

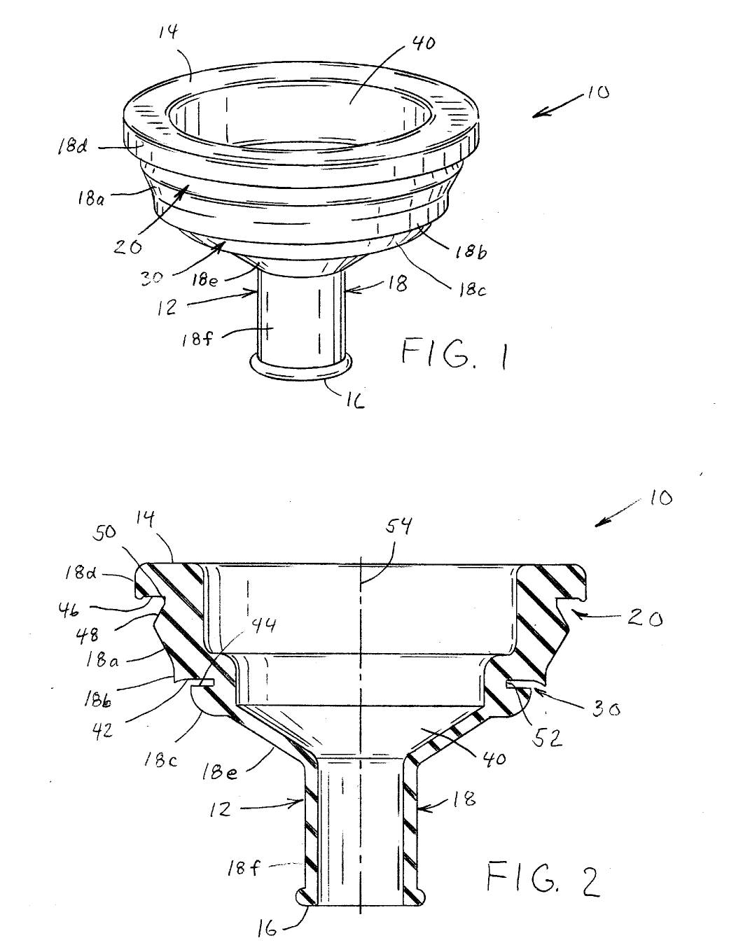

Referring now to the drawings wherein the showings are for purposes of illustrating one more exemplary embodiments and not for purposes of limiting same, a vehicle grommet for use in vehicle assembly is illustrated in FIGS. 1 and 2 and is generally indicated by reference 10. The vehicle grommet 10 includes a cylindrical body 12 having a first axial end 14 and a second axial end 16. The cylindrical body 12 additionally includes an outer wall 18 extending from the first axial end 14 to the second axial end 16. As will be described in more detail below, the second axial end 16 is adapted to be inserted through a grommet aperture defined in an associated panel.

As shown, the vehicle grommet includes a first circumferential groove 20, which can also be referred to as a first aperture. The first circumferential groove 20 is defined into the cylindrical body 12 at a first location between the first and second axial ends 14, 16. The first circumferential groove 20 is also specifically defined in the outer wall 18 and is sized to accommodate the associated panel when the grommet aperture has a first diameter. The vehicle grommet also includes a second circumferential groove 30, which can also be referred to as a second aperture. The second circumferential groove 30 is defined in the cylindrical body 12 at a second location space between the first and second axial ends 14, 16 and is spaced apart from the first circumferential groove 20. The second circumferential groove 30 is also specifically defined in the outer wall 18 but is sized to accommodate the associated panel when the grommet aperture has a second diameter that is smaller than the first diameter.

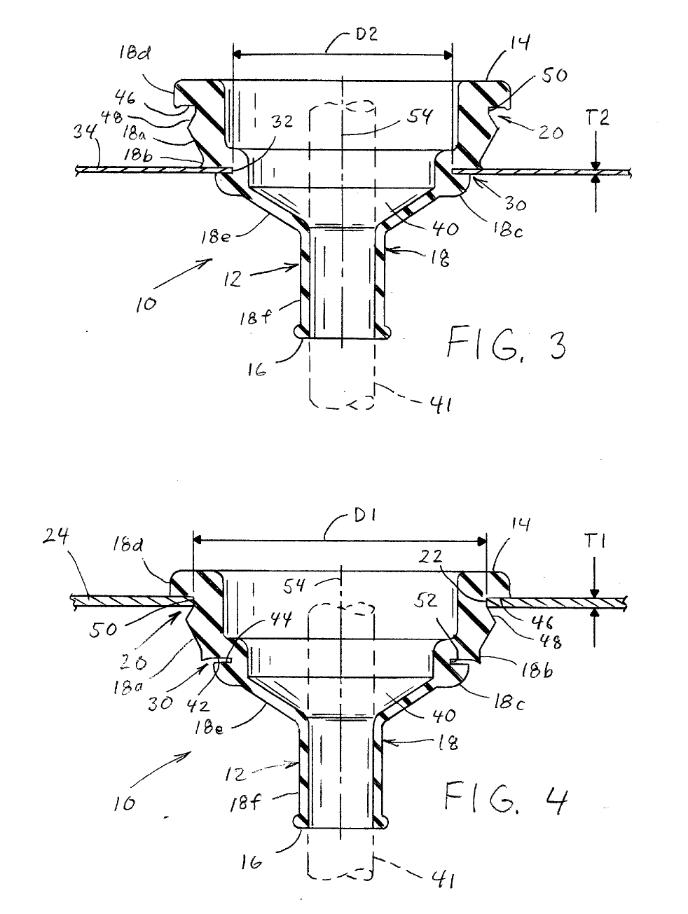

In particular, the first circumferential groove 20 is configured to mount the cylindrical body 12 within a first panel aperture defined in an associated first panel (e.g., a first panel aperture 22 defined in a first panel 24 shown in FIG. 4) and the second circumferential groove 30 is configured to mount the cylindrical body 12 within a second panel aperture defined in an associated second panel (e.g., a second panel aperture 32 defined in a second panel 34 shown in FIG. 3). Advantageously, a first panel aperture diameter of the first panel aperture varies relative to a second panel aperture diameter of the second panel aperture (e.g., first panel aperture diameter D1 varies relative to second panel aperture diameter D2). For example, the first panel aperture diameter can be larger than the second panel aperture diameter. In one embodiment, the first panel aperture diameter is 60 mm and the second panel aperture diameter is 45 mm.

In addition, the first circumferential groove 20 is adapted to accommodate the associated first panel having a first panel thickness (e.g., first panel 24 having first panel thickness T1 shown in FIG. 4) that is defined within a range of first panel thicknesses and the second circumferential groove 30 is adapted to accommodate the associated second panel having a second panel thickness (e.g., second panel 34 having second panel thickness T2 shown in FIG. 4) that is defined within a range of second panel thicknesses. Advantageously, the range of first panel thicknesses can vary relative to the range of second panel thicknesses, though this is not required. In the illustrated embodiment, the first and second circumferential grooves 20, 30 are configured such that the range of first panel thicknesses is less than the range of second panel thicknesses, but overlaps slightly. For example, the range of first panel thicknesses can be a range of 0.8 mm to 1.4 mm and the range of second panel thicknesses can be a range of 0.5 mm to 0.8 mm. It is to be appreciated and understood that these ranges can vary from this example (e.g., the ranges can be different than specified, the amount of overlap could be increased, there could be no overlap, the range of second panel thicknesses could be larger than the range of first panel thicknesses, etc.).

More specifically, in the illustrated embodiment, the outer wall 18 of the cylindrical body 12 is a tapered outer wall in which the first and second circumferential grooves 20, 30 are defined, though this is not required. The tapered outer wall 18 of the illustrated embodiment has a larger diameter adjacent the first axial end 14 then adjacent the second axial end 16. Additionally in the illustrated embodiment, the first circumferential groove 20 is more adjacent the first axial end 14 than is the second circumferential groove 30. Also particular to the illustrated embodiment, the tapered outer wall 18 includes an obliquely angled straight section 18a between the first and second circumferential grooves 20, 30. In particular, the tapered outer wall 18 includes a flared section 18b between the first and second circumferential grooves, 20, 30 and immediately adjacent the second circumferential groove 30. In addition, the obliquely angled straight section 18a extends from the flared section 18b to the first circumferential groove 20.

Still further, the tapered outer wall 18 of the illustrated embodiment includes a rounded profile section 18c adjacent the second circumferential groove 30 (e.g., immediately adjacent the second circumferential groove 30 in the illustrated embodiment) and positioned between the second circumferential groove 30 and the second axial end 16. Further still, the tapered outer wall 18 includes a head section 18d disposed between the first circumferential groove 20 and the first axial end 14. Another obliquely angled straight section 18e is disposed between the second circumferential groove 30 and the second axial end 16, and more particularly between the rounded profile section 18c and a tubular section 18f disposed immediately adjacent the second axial end 16. Collectively, the sections 18a, 18b, 18c, 18d and 18e form an enlarged head portion of the cylindrical body 12 in which the first and second circumferential grooves 20, 30 are defined and the tubular section 18f forms a tubular portion of the cylindrical body 12 that has a reduced diameter relative to the enlarged head portion.

The cylindrical body 12 can define an axial throughole 40 extending from the first axial end 14 to the second axial end 16 for receiving at least one wire 41 (FIGS. 3 and 4). As shown in the illustrated embodiment, the diameter of the axial throughole 40 is greater adjacent the first axial end 14 than adjacent the second axial end 16. In particular, the diameter of the axial throughole 40 can generally correspond to the sections 18a-18f with the diameter being larger for the sections 18a-18e that comprise the enlarged head portion and smaller for the section 18f corresponding to the tubular portion. More specifically, and particular to the illustrated embodiment, the diameter of the axial throughole 40 adjacent the first axial end 14 can be at least twice as large as the diameter adjacent the second axial end 16.

The first circumferential groove 20 can have a first groove shape and the second circumferential groove 30 can have a second groove shape. The first groove shape can vary relative to the first groove shape. This can advantageously enable the vehicle grommet 10 to be used with different panel types (e.g., panel types of varying thicknesses). In the illustrated embodiment, the first groove shape is one of a U-shape and a V-shape and the second groove shape is the other of the U-shape and the V-shape. Particularly, in the illustrated embodiment, the first groove shape is the V-shape and the second groove shape is the U-shape. As shown, the U-shape can be formed by spaced apart radial walls 42, 44 that are generally parallel to one another with a base wall 52 extending between the radial walls 42, 44, whereas the V-shape can be formed by the radial walls 46, 48 that are obliquely angled relative to one another. More particularly, the radial walls 46, 48 of the V-shape converge toward one another to define an inner apex portion 50 of the V-shape, whereas the radial walls 42, 44 define the base wall 52. Specific to the illustrated embodiment, the radial walls 46, 48 of the V-shape include the radial wall 46, which can be referred to as a first radial wall, being orthogonally oriented relative to an axis 54 defined by the cylindrical body 12 and the radial wall 48, which can be referred to a second radial wall, being obliquely oriented relative to the axis 54.

With further reference to FIGS. 3 and 4, the first and second circumferential grooves 20, 30 have varying diameters relative to one another. As shown, the first panel 24 has the first panel aperture 22 defined therein having a first panel aperture diameter D1 and the second panel 34 has the second panel aperture 32 defined therein having a second panel diameter D2. In particular, the second panel aperture D2 varies relative to the first panel aperture diameter D1 (e.g., D2 is smaller in the illustrated embodiment than D1). In one specific embodiment, the first panel aperture diameter D1 is 60 mm and the second panel aperture diameter D2 is 45 mm, though other dimensions can be used.

Additionally, and optionally, the first and second circumferential grooves 20, 30 are configured so that the grooves 20, 30 can accommodate vehicle panels of varying thicknesses, such as the first panel 24 having the first panel thickness T1 and the second panel 34 having the second panel thickness T2 where the second panel thickness T2 varies relative to the first panel thickness T1. As described hereinabove, the first circumferential groove 20 can be specifically sized to accommodate the first panel 24 when the first panel 24 has the first panel thickness T1 that is within a range of first panel thicknesses (e.g., 0.8 mm to 1.4 mm), and the second circumferential groove 30 can be specifically sized to accommodate the second panel 34 when the second panel 34 has the second thickness T2 that is within a range of second panel thicknesses (e.g., 0.5 mm to 0.8 mm).

In the illustrated embodiment, the range of first panel thicknesses that can be accommodated by the first circumferential groove 20 is larger or greater than the range of second panel thicknesses that can be accommodated by the second circumferential groove 30. However, the first and second ranges do have some amount of overlap for the vehicle grommet 10 of the illustrated embodiment. Accordingly, some panel thicknesses would be suitable only for the first circumferential groove 20 and other panel thicknesses would be suitable only for the second circumferential groove 30. Additionally, other panel thicknesses would be suitable for both the first and second circumferential grooves 20, 30. Nevertheless, some additional panel thicknesses would not be suitable for either the first or second circumferential grooves 20, 30. By way of example, when the range of first thicknesses is 0.8 mm to 1.4 mm and the range of second panel thicknesses is 0.5 mm to 0.8 mm, the first thickness T1 could be 1 mm and thus only able to be accommodated by the first circumferential groove 20 and the second thickness T2 could be 0.6 mm and thus only able to be accommodated by the second circumferential groove 30. Again, as mentioned above, the ranges for the grooves 20, 30 can vary from these specific amounts, including having the amount of overlap vary or having no overlap.

Advantageously, the vehicle grommet 10 can thus be used with different panels (e.g., the first panel 24 and the second panel 34) having different diameters for apertures defined through the panels (e.g., first panel aperture diameter D1 and second panel aperture diameter D2). In addition, the vehicle grommet 10 could optionally be used with different panels (e.g., the first panel 24 and the second panel 34) having different panel thicknesses (e.g., the first panel thickness T1 and the second panel thickness T2). That is, the first circumferential groove 20 could be used with panels having a thickness defined within the range of first panel thicknesses and the second circumferential groove 30 could be used with panels having a thickness defined within the range of second panel thicknesses. These features advantageously enable the vehicle grommet 10 to be used in different vehicle models employing varying panels, different vehicle types of the same model employing varying panels, or different vehicle models built on a single assembly line. In particular, a plurality of the vehicle grommets 10 could be provided in a single parts bin and the installer need not pay attention to whether or not a specific matching grommet is used because the grommet 10 is usable on varying panels and thus varying vehicle models or types.

For example, only one variety of vehicle grommet, such as vehicle grommet 10, need be supplied to an assembly line station and can accommodate differing vehicle types and/or models wherein different vehicle panels are used (e.g., panels 24 and 34). This ultimately reduces tooling and complication in the manufacturing process. If a panel has a panel aperture of a size corresponding to one of the circumferential grooves 20 or 30, the vehicle grommet 10 will automatically mate the panel to the corresponding groove. That is, if the panel aperture had a panel aperture diameter D1, then the second circumferential groove 30 would automatically receive the panel because the vehicle grommet 10 would not be able to pass through the panel aperture to the first circumferential groove 20. Alternatively, if the panel aperture had a panel aperture diameter D2, then the first circumferential groove 20 would automatically receive the panel because the second circumferential groove 30 would pass through and past the panel (i.e., because the diameter of the grommet 10 at this location is smaller than the panel aperture diameter D2).

A grommet installation method for a vehicle will now be described. In particular, the grommet installation method will be described in association with the vehicle grommet 10 described hereinabove, though this is not required and it should be appreciated by those skilled in the art that the grommet installation method could be employed with other vehicle grommets. In the method, the grommet 10 is provided having the cylindrical body 12 with the first axial end 14 and the second axial end 16. As already discussed, the cylindrical body 12 defines the first circumferential groove 20 adapted for mounting with the first panel aperture 22 defined in the first panel 24 when the first panel aperture 22 has a first panel aperture diameter (e.g., first panel aperture diameter D1) and the second circumferential groove 30 adapted to mount the cylindrical body 12 within the second panel aperture 32 defined in the second panel 34 when the second panel aperture 32 has a second panel aperture diameter (e.g., second panel aperture diameter D2), with the first panel aperture diameter varying relative to the second panel aperture diameter.

The method further includes installing the vehicle grommet 10 within the first panel 24 such that the first panel 24 is received in the first circumferential groove 20 when the first panel aperture 22 has the first panel aperture diameter (e.g., the first panel aperture diameter D1 shown in FIG. 4) and is received in the second circumferential groove 30 when the panel is the second vehicle panel 34 having the second panel aperture diameter (e.g., the second panel aperture diameter D2 shown in FIG. 3). Additionally, as described hereinabove, the first circumferential groove 20 can accommodate the associated panel having a first range of panel thicknesses and the second circumferential groove 30 can accommodate the associated panel having a second range of panel thicknesses, wherein the first range of panel thicknesses varies relative to (e.g., is greater than) the second range of panel thicknesses.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle grommet, comprising:
a cylindrical body having a first axial end and a second axial end;
a first circumferential groove defined into the cylindrical body at a first location spaced between the first and second axial ends, the first circumferential groove configured to mount the cylindrical body within a first panel aperture defined in an associated first panel; and
a second circumferential groove defined in the cylindrical body at a second location spaced between the first and second axial ends and spaced apart from the first circumferential groove, the second circumferential groove configured to mount the cylindrical body within a second panel aperture defined in an associated second panel, wherein a first panel aperture diameter of the first panel aperture varies relative to a second panel aperture diameter of the second panel aperture.

2. The vehicle grommet of claim 1 wherein the first circumferential groove is adapted to accommodate the first panel having a first panel thickness that is within a range of first panel thicknesses and the second circumferential groove is adapted to accommodate the second panel having a second panel thickness that is within a range of second panel thicknesses, and wherein the range of first panel thicknesses varies relative to the range of second panel thicknesses.

3. The vehicle grommet of claim 1 wherein the cylindrical body defines an axial throughole extending from the first axial end to the second axial end for receiving at least one wire.

4. The vehicle grommet of claim 3 wherein a diameter of the axial throughole is greater adjacent the first axial end than adjacent the second axial end.

5. The vehicle grommet of claim 4 wherein the diameter of the axial throughole adjacent the first axial end is at least twice as large as adjacent the second axial end.

6. The vehicle grommet of claim 1 wherein the first circumferential groove has a first groove shape and the second circumferential groove has a second groove shape, a shape configuration of the second groove shape is varied relative to the first groove shape.

7. The vehicle grommet of claim 6 wherein the first groove shape is one of a U-shape and V-shape and the second groove shape is the other of U-shape and V-shape.

8. The vehicle grommet of claim 7 wherein the U-shape is formed by spaced part radial walls that are generally parallel to one another and the V-shape is formed by radial walls that are obliquely angled relative to one another.

9. The vehicle grommet of claim 8 wherein the radial walls of the V-shape converge toward one another to define an inner apex portion of the V-shape.

10. The vehicle grommet of claim 8 wherein the radial walls of the V-shape include a first radial wall that is orthogonally oriented relative to an axis defined by cylindrical body.

11. The vehicle grommet of claim 1 wherein the cylindrical body has a tapered outer wall in which the first and second circumferential grooves are defined, the tapered outer wall having a larger diameter adjacent the first axial end than adjacent the second axial end, and further wherein the first circumferential groove is more adjacent the first axial end than the second circumferential groove.

12. The vehicle grommet of claim 11 wherein the tapered outer wall includes an obliquely angled straight section between the first and second circumferential grooves.

13. The vehicle grommet of claim 12 wherein the tapered outer wall includes a rounded profile section adjacent the second circumferential groove and positioned between the second circumferential groove and the second axial end.

14. The vehicle grommet of claim 1 wherein the cylindrical body includes an enlarged head portion in which the first and second circumferential grooves are defined and a reduced tubular portion having a reduced diameter relative to the enlarged head portion.

15. A wire harness grommet for use in vehicle assembly, comprising:
a body having a first end and a second end with an outer wall extending from the first end to the second end, the second end adapted to be inserted through a grommet aperture defined in an associated panel;
a first aperture defined in the outer wall and sized to accommodate the associated panel when the grommet aperture has a first diameter; and
a second aperture defined in the outer wall and sized to accommodate the associated panel when the grommet aperture has a second diameter that is smaller than the first diameter.

16. The wire harness grommet of claim 15 wherein the body has a cylindrical shape with an axial throughole extending from the first end to the second end, and wherein the first and second apertures are circumferential grooves defined in the outer surface have varying diameters relative to one another.

17. The wire harness grommet of claim 15 wherein the first aperture is further sized to accommodate the associated panel when the associated panel has a first thickness defined within a range of first panel thicknesses and the second aperture is further sized to accommodate the associated panel when the associated panel has a second thickness defined within a range of second panel thicknesses, the range of first panel thicknesses varies relative to and is less than the range of second panel thicknesses.

18. A grommet installation method for a vehicle, comprising:
providing a grommet having a cylindrical body with a first axial end and a second axial end, the cylindrical body defining a first circumferential groove adapted for mounting within a panel aperture defined in an associated panel when the panel aperture has a first panel aperture diameter and a second circumferential groove adapted to mount the cylindrical body within the panel aperture when the panel aperture has a second panel aperture diameter, wherein the first panel aperture diameter varies relative to the second panel aperture diameter; and
installing the grommet within the associated panel such that the associated panel is received in the first circumferential groove when the panel aperture has the first panel aperture diameter and is received in the second circumferential groove when the panel aperture has the second panel aperture diameter.

19. The method of claim 18 wherein the first circumferential groove accommodates the associated panel having a first range of panel thicknesses and the second circumferential groove accommodates the associated panel having a second range of panel thicknesses, the first range of panel thicknesses varying relative to the second range of panel thicknesses.
